(19) United States
(12) Patent Application Publication
(10) Pub. No.: US 2020/0187427 A1
(43) Pub. Date: Jun. 18, 2020

(54) VERTICAL FARMING SYSTEM WITH PLANT DISPLACEMENT ASSEMBLY AND IRRIGATION UNIT FOR VERTICAL FARMING SYSTEM

(71) Applicant: Inno-3B Inc., St-Pacome (CA)

(72) Inventor: Martin Brault, St-Pacome (CA)

(21) Appl. No.: 16/712,166

(22) Filed: Dec. 12, 2019

Related U.S. Application Data
(60) Provisional application No. 62/778,378, filed on Dec. 12, 2018.

(51) Int. Cl. A01G 9/02

(52) U.S. Cl. CPC A01G 9/027; A01G 27/00; A01G 9/022

(57) ABSTRACT

A vertical farming system comprising: a plant storage frame including a plurality of horizontal guiding members; a plurality of plant receiving trays received on a corresponding horizontal guiding member for receiving a plurality of plants, the plant receiving trays being disposed adjacent each other and being laterally movable along the horizontal guiding members towards and away from an open front end of the storage frame, the plant receiving trays being connectable to each other such that movement of one of the plant receiving trays in a lateral direction moves the remaining plant receiving trays in the same lateral direction, the plant receiving trays being detachable from each other to allow each plant receiving tray to be removed from the storage frame through the open front end to be tended individually from the other plant receiving trays.

### CROSS-REFERENCE TO RELATED APPLICATIONS

The present claims priority from U.S. Provisional Patent Application No. 62/778,378 filed on Dec. 12, 2018, the specification of which is incorporated herein by reference.

### TECHNICAL FIELD

The technical field generally relates to vertical farming, and more precisely to plant displacement assemblies for vertical farming systems. The technical field also relates to irrigation units for vertical farming systems and to methods for irrigating plants in a vertical farming system.

### BACKGROUND

Vertical farming is the practice of cultivating plants in a vertical farming system which includes a plurality of vertically stacked layer structures. This type of farming makes use of new farming techniques, such as controlling the farming environment and making use of new equipment, such as artificial light. It also introduces various new challenges over traditional methods of farming.

The plants cultivated in the vertical farming system may periodically need to be tended. Tending the plants may include, for example, irrigating, pruning, examining or harvesting the plants. When the plants are received in the vertical farming system, it may be difficult to have access to the plant for tending since the layer structures are stacked on top of each other. The plants may also be relatively high above a ground surface and may require a worker to climb a ladder or an elevation assembly to gain access to the plants, which would be relatively inefficient as well as create a risk of injury for the worker.

It may be practical to tend the plants at a tending station away from the stacked layer structures but moving the plants from the stacked layer structures to the tending station may be complex and cumbersome.

### SUMMARY

According to one aspect, there is provided a vertical farming system comprising: a plant storage frame including a plurality of horizontal guiding members spaced apart vertically from each other, the plant storage frame having an open front end for allowing access into the storage frame; a plurality of plant receiving trays received on a corresponding horizontal guiding member for receiving a plurality of plants, the plant receiving trays being disposed adjacent to each other and substantially in a common plane to define a vertical farming layer, the plant receiving trays being laterally movable along the horizontal guiding members towards and away from the open front end of the storage frame, the plant receiving trays being connectable to each other such that movement of one of the plant receiving trays in a lateral direction moves the remaining plant receiving trays in the same lateral direction, the plant receiving trays being further detachable from each other to allow each plant receiving tray to be removed from the storage frame through the open front end to be tended individually from the other plant receiving trays.

In at least one embodiment, each tray includes a front tray end located towards the front end of the storage frame and a rear tray end located away from the front end of the storage frame, the rear tray end of each tray being detachably connectable to the front tray end of an adjacent plant receiving tray located rearwardly from the tray such that when the front one of the plant receiving trays is moved laterally along the horizontal members, the remaining plant receiving trays are also moved laterally along the horizontal members.

In at least one embodiment, each tray includes a bottom panel having an outer panel edge and a tray sidewall extending upwardly from the outer panel edge.

In at least one embodiment, the tray sidewall includes a front tray wall located at the front tray end and a rear tray wall located that the rear tray end, the front tray wall including a first connecting portion and the rear tray wall including a second connecting portion configured engageable with the first connecting portion such that the second connecting portion of each tray is configured to engage the first connecting portion of the adjacent plant receiving tray located rearwardly from the tray.

In at least one embodiment, the second connecting portion includes a hook member having a hook recess facing downwardly to receive the first connecting portion of the adjacent plant receiving tray located rearwardly from the tray.

In at least one embodiment, the first connecting portion includes a connecting flange projecting frontwardly from the front tray wall, the connecting flange being sized and shaped to be snuggly received in the hook recess of the second connecting portion.

In at least one embodiment, each tray includes a tray base having a plurality of cut-out portions and a plurality of plant containers containing the plants, each cut-out portion being sized and shaped to removably receive a corresponding plant container.

In at least one embodiment, the system further comprises: at least one tending unit for tending to plants; a tray displacement assembly disposed adjacent the open front end of the plant storage frame for selectively moving at least one of the plant receiving trays from the plant storage frame to one of the at least one tending unit for tending to the plants received in the at least one of the plant receiving trays and from the at least one tending unit to the plant storage frame to return the at least one of the plant receiving trays to storage in a corresponding vertical farming layer.

In at least one embodiment, the tray displacement assembly includes: a displacement platform sized and shaped to receive the front one of the plant receiving trays; a tray extraction mechanism mounted to the displacement platform for engaging the front one of the plant receiving trays received in the storage frame at a first vertical level and for moving the front one of the plant receiving trays laterally outwardly from the storage frame onto the displacement platform; and an actuator operatively connected to the displacement platform to move the displacement platform vertically to thereby move the front one of the plant receiving trays vertically to the one of the at least one tending units located at a second vertical level different from the first vertical level.

In at least one embodiment, the at least one plant tending unit includes an irrigation unit for irrigating the plants received in the plant receiving tray.

In at least one embodiment, the plant receiving trays are slidably received on the horizontal members.

According to another aspect, there is also provided a method for tending to plants, the method comprising: providing a vertical farming system as defined above; providing at least one tending unit for tending to the plants and a tray displacement assembly disposed adjacent the open front end of the plant storage frame; using the tray displacement assembly, moving a front one of the plant receiving trays laterally outwardly from one of the vertical farming layers of the storage frame through the open front end; and using the tray displacement assembly, moving the front one of the plant receiving trays vertically relative to the storage frame towards one of the at least one tending unit.

In at least one embodiment, the front one of the plant receiving trays is removably connected to an adjacent plant receiving tray located rearwardly from the front tray one of the plant receiving trays, the method further comprising: after moving the front one of the plant receiving trays laterally outwardly from one of the vertical farming layers, moving the front one of the plant receiving trays upwardly to disconnect the front one of the plant receiving trays from the adjacent plant receiving tray.

In at least one embodiment, the method further comprises: after moving the front one of the plant receiving trays upwardly, moving the front one of the plant receiving trays laterally outwardly from the plant storage frame until the front one of the plant receiving trays is spaced horizontally from the adjacent plant receiving tray to allow the front one of the plant receiving trays to clear the adjacent plant receiving tray when the front one of the plant receiving trays is further moved vertically.

According to yet another aspect, there is also provided an irrigation unit for a vertical farming system, the vertical farming system including at least one plant receiving tray for receiving plants thereon, the at least one plant receiving tray including a bottom panel having at least one irrigation opening, the irrigation unit comprising: an irrigation unit frame; an irrigation basin secured to the irrigation unit frame for receiving an irrigation fluid; a tray dipping assembly movably connected to the irrigation unit frame for receiving at least one plant receiving tray, the tray dipping assembly being movably connected to the irrigation unit frame for moving the plant receiving tray vertically towards the irrigation basin until the bottom panel of the plant receiving tray is at least partially immersed in the irrigation fluid in the irrigation basin to thereby provide irrigation fluid to the plants through the at least one irrigation opening of the plant receiving tray.

In at least one embodiment the irrigation unit further comprises at least one guide assembly connected to the frame for guiding the tray towards the irrigation basin.

In at least one embodiment the tray dipping assembly includes a tray support member movably connected to the irrigation frame, the tray support member being configured for receiving the at least one plant receiving tray, the tray dipping assembly further comprising at least one actuator operatively connected to the tray support member for vertical movement of the tray support member.

In at least one embodiment the at least one actuator includes a first actuator operatively connected to a first side of the tray support member and a second actuator operatively connected to a second side of the tray support member located opposite the first side, the first actuator being operable individually from the second actuator for raising one of the first and second sides of the tray support member relative to the other one of the first and second sides of the tray support member to thereby incline the at least one plant receiving tray received on the tray support member.

According to yet another aspect, there is also provided a method for irrigating plants in a vertical farming system, the method comprising: providing plants in a plant receiving tray, the plant receiving tray including a bottom panel having at least one irrigation opening; positioning the plant receiving tray on a tray dipping assembly of an irrigation unit, the irrigation unit comprising an irrigation basin located below the tray dipping assembly, the irrigation basin containing an irrigation fluid; using the tray dipping assembly, moving the plant receiving tray vertically downwardly towards the irrigation basin until the bottom panel is at least partially immersed in the irrigation fluid in the irrigation basin to thereby irrigate the plants with the irrigation fluid through the at least one irrigation opening of the plant receiving tray.

In at least one embodiment, the method further comprises: after moving the plant receiving tray vertically downwardly towards the irrigation basin, inclining the plant receiving tray using the tray dipping assembly.

In at least one embodiment the method further comprises: before positioning the plant receiving tray on a tray dipping assembly, moving the plant receiving tray from a plant storage frame of the vertical farming system towards the tray dipping assembly.

According to yet another aspect, there is also provided a vertical farming system comprising: a plant storage area for storing a plurality of plants in a plurality of vertical farming layers; a tending unit located remotely from the plant storage area for tending to the plants when the plants are received in the tending unit; a plant displacement assembly disposed between the plant storage area and the tending unit for selectively moving at least one plant from the storage area to the tending unit to allow the at least one plant to be tended and from the tending unit to the plant storage area to allow the plant unit to be returned to storage.

In at least one embodiment, the tending unit includes an irrigation unit for irrigating the plants.

In at least one embodiment, the system further includes a plurality of plant receiving trays disposed in the plant storage area, the plant receiving trays being configured for receiving the plants, the plant displacement assembly being adapted for selectively moving each plant receiving tray individually away from the other plant receiving trays towards the tending unit to allow each plant receiving tray to be tended individually.

### BRIEF DESCRIPTION OF THE DRAWINGS

FIG. 1A is a top perspective view of a vertical farming system, in accordance with one embodiment, with a side wall removed to better illustrate the components of the system;

FIG. 1B is a side elevation view of the vertical farming system illustrated in FIG. 1A, with horizontal guiding members located in the foreground removed to better show the plant receiving trays;

FIG. 2 is a top perspective view of a displacement platform for the vertical farming system illustrated in FIG. 1A;

FIG. 3 is another top perspective view of a displacement platform for the vertical farming system illustrated in FIG. 1A;

FIG. 4 is a bottom plan view of an upper platform portion of the displacement platform illustrated in FIGS. 2 and 3;

FIG. 5 is a top perspective view of a plant receiving tray for the vertical farming system illustrated in FIG. 1A;

FIG. 6 is a bottom perspective view of a plant receiving tray for the vertical farming system illustrated in FIG. 1A;

FIG. 7 is an end elevation view of a plant receiving tray for the vertical farming system illustrated in FIG. 1A;

FIG. 8 is a side elevation view of a plant receiving tray for the vertical farming system illustrated in FIG. 1A;

FIG. 9A is an enlarged portion of a front plant receiving tray and an adjacent plant receiving tray for the vertical farming system illustrated in FIG. 1A, with a rear connecting portion of the front plant receiving tray engaging a front connecting portion of the adjacent plant receiving tray;

FIG. 9B is an enlarged portion of a front plant receiving tray and an adjacent plant receiving tray for the vertical farming system illustrated in FIG. 1A, with the rear connecting portion of the front plant receiving tray disengaged from the front connecting portion of the adjacent plant receiving tray;

FIG. 9C is an enlarged portion of a front plant receiving tray and an adjacent plant receiving tray for the vertical farming system illustrated in FIG. 1A, with the front plant receiving tray moved horizontally away from the adjacent plant receiving tray;

FIG. 10 is a top perspective view of an irrigation unit for a vertical farming system, in accordance with one embodiment;

FIG. 11 is a bottom perspective view of the irrigation unit illustrated in FIG. 10;

FIG. 12A is a cross-section view, taken along line 12-12, of the irrigation unit illustrated in FIG. 11, with a plant receiving tray held horizontally above an irrigation basin containing irrigation fluid;

FIG. 12B is a cross-section view, taken along line 12-12, of the irrigation unit illustrated in FIG. 11, with the plant receiving tray held horizontally and lowered in the irrigation basin containing irrigation fluid;

FIG. 12C is a cross-section view, taken along line 12-12, of the irrigation unit illustrated in FIG. 11, with a plant receiving tray inclined in a first inclination direction;

FIG. 12D is a cross-section view, taken along line 12-12, of the irrigation unit illustrated in FIG. 11, with a plant receiving tray inclined in a second inclination direction;

FIG. 12E is a cross-section view, taken along line 12-12, of the irrigation unit illustrated in FIG. 11, with a plant receiving tray held in horizontal alignment with a row of brushes;

FIG. 13 is a top perspective view of an irrigation unit for a vertical farming system, in accordance with another embodiment;

FIG. 14 is a side elevation view of the irrigation unit illustrated in FIG. 13, with a plant receiving tray held horizontally above an irrigation basin containing irrigation fluid; and

FIG. 15 is a side elevation view of the irrigation unit illustrated in FIG. 13, with the plant receiving tray held horizontally and lowered in the irrigation basin containing irrigation fluid.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

For the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “top”, “bottom”, “forward”, “rearward” “left”, “right” and the like should, unless otherwise indicated, be taken in the context of the figures and correspond to the position and orientation in the vertical farming system and corresponding parts when being used. Positional descriptions should not be considered limiting.

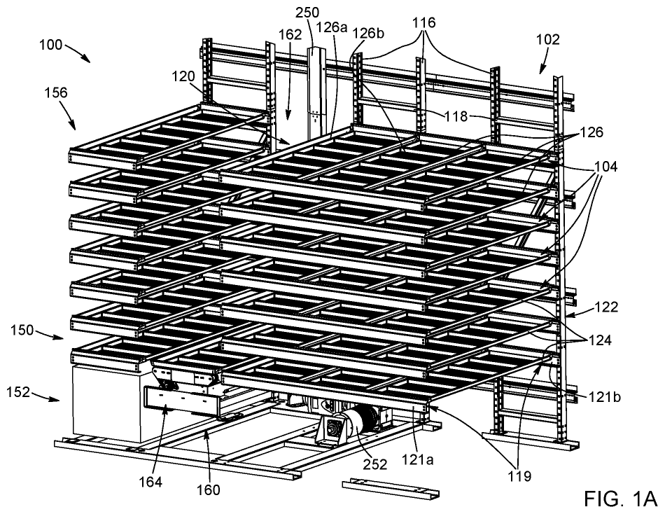

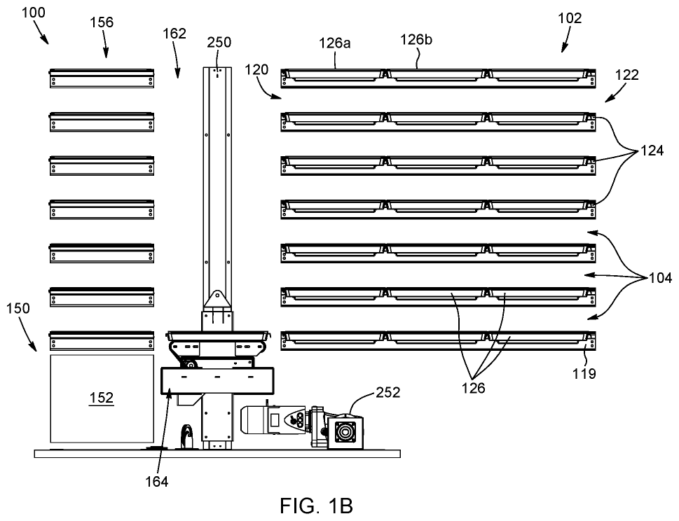

Referring now to FIGS. 1A and 1B, there is shown a vertical farming system 100 in accordance with one embodiment. In the illustrated embodiment, the vertical farming system 100 includes a plant storage frame 102 for receiving and storing plants. More specifically, the frame 102 includes multiple vertical farming layers 104 disposed on top of each other with each layer 104 being adapted to receive a corresponding plurality of plants. It will be understood that this configuration allows a relatively large number of plants to be cultivated and grown while requiring a relatively reduced floorspace.

In one embodiment, the frame 102 may be received in a rectangular housing, not shown, which insulates the frame 102 from the environment. This may allow environmental conditions, such as the temperature, the level of humidity, the luminosity or the like, inside the housing and in the frame 102 to be controlled independently from the conditions in the environment. The housing may include a roof, a floor opposite the roof, a generally vertical front wall and a generally vertical rear wall opposite and parallel to the front wall. The housing may further include a pair of lateral walls extending vertically between the front and rear walls to thereby generally enclose the frame 102 within the housing. The walls of the housing could be made of a rigid material such as a metal or any other suitable material. Alternatively, the housing could include an entire room of a building structure in which the frame 102 is located. In yet another embodiment, the frame 102 may not include any housing.

In the illustrated embodiment, the frame 102 includes a plurality of vertical support members 116 and a plurality of horizontal frame members 118 secured to the vertical support members 116. Still in the illustrated embodiment, the plant storage frame 102 includes an open front end 120 for allowing access to the farming layers 104 of the storage frame 102 and a rear end 122 opposite the front end 120. In one embodiment, the rear end 122 may be closed by the rear wall of the housing, in contrast with the front end 120 which is open. Alternatively, the rear end 122 could instead be open, similarly to the front end 120, to allow access to the farming layers 104 from both the front end 120 and the rear end 122.

The frame 102 further includes a plurality of horizontal guiding member 119 and a plurality of floor members 124 which are adapted to engage the horizontal guiding members 119. More specifically, each floor member 124 is adapted to receive the plants thereon and extends generally between the front and rear ends 122 of the frame 102. Each floor member 124 engages a corresponding horizontal guiding member 119 and is thereby maintained in a substantially horizontal orientation. As shown in FIGS. 1A and 1B, the horizontal guiding members 119 are spaced apart vertically from each other, and therefore the floor members 124 are also spaced apart vertically from each other. Each vertical farming layer 104 is therefore defined between two spaced-apart floor members 124.

The vertical farming system 100 may further include one or more additional plant care systems such as artificial light systems or the like, not shown, which may be secured to the frame 102 and may be oriented downwardly towards the floor member 124 of the vertical farming layer 104 located immediately below. Alternatively, the vertical farming system 100 may not include any additional plant care systems.

In the illustrated embodiment, instead of including a single, unitary member which would extend between the front end 120 and the rear end 122 of the storage frame 102, each floor member 124 is divided into a plurality of plant receiving trays 126 which are distinct from each other and connected to each other. Each plant receiving tray 126 is configured for receiving a plurality of plants. Since all the trays 126 are separate from each other, this configuration allows the plants in each tray 126 to be tended independently or individually from the other trays 126. More specifically, each plant receiving tray 126 may be extracted from the storage frame 102 to allow the plants received on the tray 126 to be tended at one of a plurality of tending station or tending units 150 which are remote from the storage frame 102. For example, the tending units 150 may include an irrigation unit 152 in which the plants are irrigated, as will be further explained below. The tending units 150 may further include one or more workstations in which the plants on the tray 126 is made accessible to one or more workers for planting, pruning, examining, harvesting or the like.

It will be appreciated that tending the plants remotely from the plant storage frame may reduce the costs of building and operating the vertical farming system 100, as well as improve the system's efficiency. For example, irrigating the plants by moving each tray 126 individually towards the irrigation unit 152 eliminates the need to provide multiple irrigation systems to irrigate the multiple vertical farming layers 104. Irrigating the plants at a dedicated irrigation station located remotely from the plant storage frame 102 may further contribute to improving the plant's irrigation by allowing a better control of the irrigation process, and/or may further facilitate the drainage of water during the irrigation process. Moreover, this configuration may allow the tending units 150 to be placed in an environment in which the environmental conditions, e.g. humidity, luminosity, are different than the conditions in the plant storage frame 102 to allow the plants to be tended in different environmental conditions.

In one embodiment, the tending units 150 may be located on different levels and be superposed on top of each other to form a tending unit column 156 facing the plant storage frame 102. Alternatively, the tending units 150 could instead be located adjacent each other on a same vertical level. In another embodiment, the tending units 150 could be located further remotely of the storage frame 102 and remotely from each other. In yet another embodiment, additional plant receiving trays could be positioned above or be alternated with one or more tending units 150 in the tending unit column 156. In yet another embodiment, the tending unit column 156 could include an access opening defined between vertically space-apart tending units 150 or tending units 150 and trays 126 to provide access to the trays 126 such that the trays 126 may be selectively moved away from the frame 102 or returned to the frame 102.

As shown in FIGS. 1A and 1B, the plant receiving trays 126 are located in multiple vertical farming layers 104 and therefore are located on multiple vertical levels. Although the plant receiving trays 126 on one of the vertical farming layers 104 may be vertically aligned with at least one of the tending units 150, the trays 126 in the other vertical farming units 104 are located on different vertical levels and may need to be displaced vertically towards a desired tending unit 150 once the tray 126 has been extracted from the storage frame 102 to be tended at the desired tending unit 150.

In the illustrated embodiment, the vertical farming system 100 includes a tray displacement assembly 160 disposed adjacent the open front end 120 of the plant storage frame 102 for extracting a front plant receiving tray 126a, located adjacent the front end 102, from one of the vertical farming layers 104 of the storage frame 102 and for moving the front plant receiving tray 126a vertically relative to the storage frame 102 towards the desired tending unit 150.

The tray displacement assembly 160 is received in a vertical displacement space 162 located adjacent the front end 120 of the storage frame 102. The vertical displacement space 162 substantially defines a vertical pathway, similar to an elevator shaft, in which the tray displacement assembly 160 may move vertically to allow the tray displacement assembly 160 access to all of the vertical farming layers 104.

In the illustrated embodiment, the trays 126 are slidably mounted on the horizontal guiding members 119 and are adapted to move towards and away from the open front end 120 of the storage frame 102. More specifically, each horizontal guiding member 119 includes a pair of spaced-apart guiding rails 121a, 121b which allow the trays 126 to slidably move along the horizontal guiding member 119 towards the front end 120 of the storage frame 120 or towards the rear end 122, but prevents movement of the trays 126 transversely. The spaced-apart guiding rails 121a, 121b may include any suitable elongated rail element, such as L-shaped angle bars or the like. Alternatively, the horizontal guiding members 119 may not include guiding rails, but may instead include any other member which could receive the trays 126, maintain the trays 126 in a horizontal orientation and allow the trays 126 to move laterally along the horizontal guiding members 119. For example, the horizontal guiding members 119 could instead include horizontal panels defining a solid floor of each vertical farming layer 104, and the trays 126 could be received on a corresponding horizontal panel. In other embodiments, the horizontal guiding members 119 may include any other guiding member which a skilled person would consider to be suitable.

Still referring to FIGS. 1A and 1B, the vertical displacement space 162 is sized and shaped to be able to receive the front plant receiving tray 126a located in one of the vertical farming layers 104 adjacent the front end 120 of the storage frame 102. More specifically, the tray displacement assembly 160 includes a displacement platform 164 sized and shaped to receive the front plant receiving tray 126a. The displacement platform 164 is further adapted to move vertically within the vertical displacement space 162. In the illustrated embodiment, the displacement platform 164 engages a vertical rail 250 which guides the displacement platform 164 vertically along the vertical displacement space 162. Alternatively, the displacement platform 164 may engage more than one vertical rail or may engage any other type of guiding member which would guide the displacement platform 164 vertically along the vertical displacement space 162. In yet another embodiment, the displacement platform 164 may not engage any guiding member.

The tray displacement assembly 160 further includes a platform actuator 252 operatively connected to the displacement platform 164 to move the displacement platform 164 vertically within the vertical displacement space 162. When the front plant receiving tray 126a is received on the displacement platform 164, the front plant receiving tray 126a, originally located on a first vertical level, may therefore be moved vertically to the desired tending unit 150 located at a second vertical level different from the first vertical level. In the illustrated embodiment, the platform actuator includes a rotating actuator such as an electrical motor or the like and one or more cables or chain, not shown, connected to the displacement platform 164 via one or more pulleys, also not shown, so as to selectively pull the displacement platform 164 upwardly and downwardly. Alternatively, the platform actuator may instead include a linear actuator, such as a pneumatic actuator, or any other type of actuator that a skilled person would consider to be appropriate.

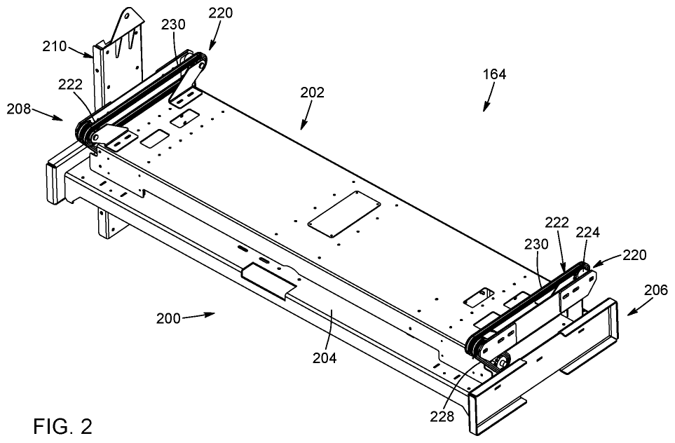

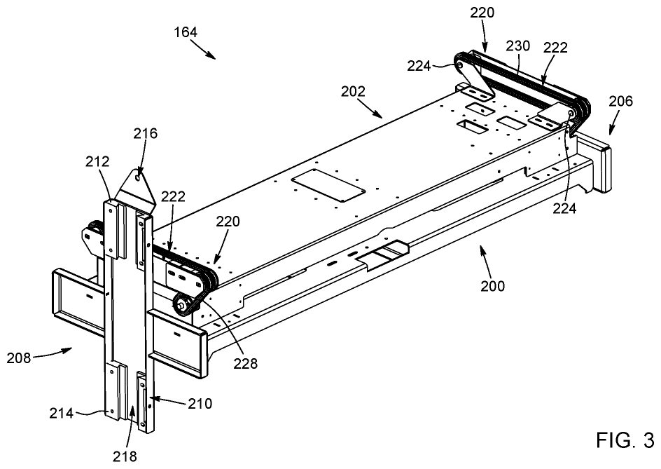

Referring to FIGS. 2 to 4, the displacement platform 164 includes a lower platform portion 200 and an upper platform portion 202 received on the lower platform portion 200 and supported by the lower platform portion 200.

The lower platform portion 200 includes a substantially planar body 204 having a first end 206 and a second end 208 opposite the first end 206, and a bracket member 210 located at the second end 206. Specifically, the bracket member 210 is generally elongated and extends generally perpendicular to the planar 204, between an upper end 212 and a lower end 214. The bracket member 210 further includes an attachment opening 216 located proximal to the upper end 212 of the bracket member 210. The attachment opening 216 is adapted for attaching a chain or cable of the platform actuator 252 to the displacement platform 164 for moving the displacement platform 164 vertically, as explained above.

In the illustrated embodiment, the bracket member 210 further includes a dovetail-shaped vertical recess 218 which is sized and shaped to engage the correspondingly-shaped vertical rail 250. This ensures that the planar body 204 of the lower platform portion 200 remains substantially horizontal as the displacement platform 164 moves vertically upwardly and downwardly. Alternatively, the vertical recess 218 could have a different shape, or the bracket member 210 may not include a vertical recess 218.

The tray displacement assembly 160 further includes a tray extraction mechanism 220 mounted to the displacement platform 164 for engaging the front plant receiving tray 126a and for moving the front plant receiving tray 126a laterally outwardly from the storage frame 102 along the horizontal guiding members 119 and onto the displacement platform 164.

In the illustrated embodiment, the tray extraction mechanism 220 is provided in the upper platform portion 202 and includes first and second friction belts 222 which are each looped around a pair of pulleys 224 and an extraction motor 226 operatively connected to the pulleys 224 via a drive belt 228. The pulleys 224 are adapted to rotate about rotation axes which extend parallel to each other and to the planar body 204 of the lower platform portion 200. The pulleys 224 are further sized and shaped such that each friction belt 222 defines an upper belt portion 230 which is substantially parallel to the planar body 204 of the lower platform portion 200, and which is therefore substantially horizontal. The friction belts 222 are adapted to frictionally engage the underside of the plant receiving trays 126 such that rotation of the friction belts 222 by the extraction motor 226 moves the plant receiving tray 126 engaging the friction belts 222 laterally relative to the displacement platform 164. This allows each plant receiving trays 126 to be selectively loaded onto the displacement platform 164 and unloaded from the displacement platform 164. In one embodiment, the front plant receiving tray 126a may be disposed such that its front end extends at least slightly into the vertical displacement space 162 to allow the friction belts 222 to contact at least a portion of the front plant receiving tray 126a when the front plant receiving tray 126a is stored in the frame 102.

It will be understood that the tray extraction mechanism 220 described above is merely provided as an example, and that the tray extraction mechanism 220 could be configured according to one of various alternative embodiments. In one embodiment, the tray extraction mechanism 220 could include an actuated arm selectively extendable laterally away from the displacement platform 164 to engage a corresponding catch member extending from the front plant receiving tray 126a, the actuated arm being further retractable once the corresponding catch member has been engaged to thereby pull the front plant receiving tray 126a laterally onto the displacement platform 164. In another embodiment, the tray extraction mechanism could instead include a pair of actuated jaw members spaced apart to receive the front plant receiving tray 126a therebetween and adapted to be moved towards each other to thereby clamp the front plant receiving tray 126a.

In yet another embodiment, the tray extraction mechanism could instead include a looped member such as a cable or a chain which would be looped around a rotary actuator and be adapted to engage a corresponding catch member extending from the front plant receiving tray 126a. Alternatively, the tray extraction mechanism could include any other mechanism that a skilled person would consider to be suitable.

In the illustrated embodiment, the plant receiving trays 126 are further connected to each other such that lateral movement of one of the plant receiving trays 126 in a lateral direction along the horizontal guiding members 119 moves the remaining plant receiving trays 126 in the same lateral direction.

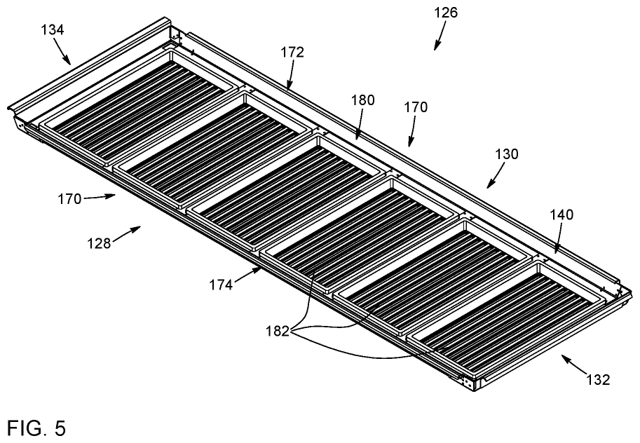

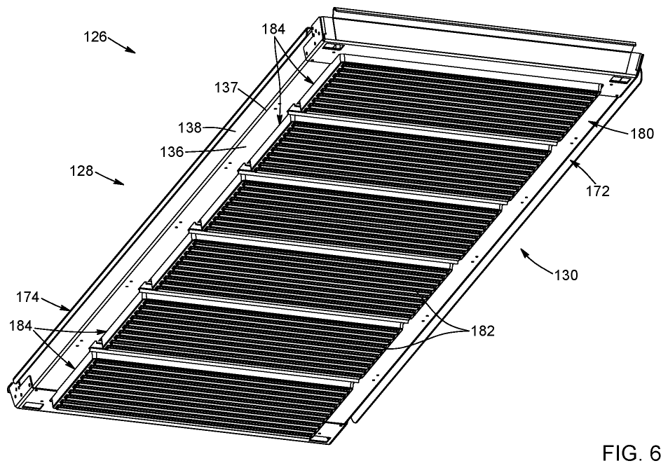

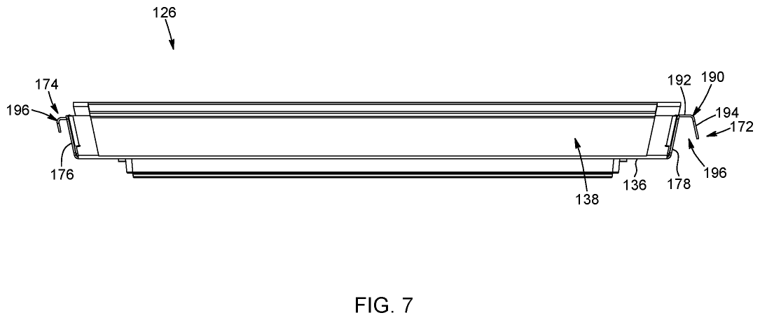

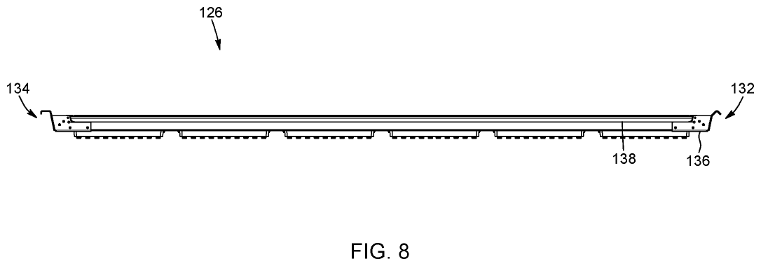

Referring now to FIGS. 1A, 1B and 5 to 8, each plant receiving tray 126 is generally rectangular and includes a front side 128 located towards the front end 120 of the storage frame 102, a rear side 130 located towards the rear end 122 and first and second lateral ends 132, 134 extending between the front and rear sides 128, 130. As best shown in FIG. 6, each tray 126 includes a bottom panel 136 having an outer panel edge 137 and a tray sidewall 138 extending upwardly from the outer panel edge 137 to define a tray recess 140 for receiving the plants.

In the illustrated embodiment, each tray 126 includes a tray base 180 and a plurality of plant containers 182 received in the tray base 180 for receiving soil, a soil substrate or a similar substance in which the plants may be planted. More specifically, the bottom panel 136 and the tray sidewall 138 form the tray base 180. The tray base 180 includes a plurality of cut-out portions 184, defined in the bottom panel 136, which are sized and shaped to receive the plant containers 182. In the illustrated embodiment, the plant containers 182 are generally rectangular and are removably received in the cut-out portions 184. Alternatively, the plant containers 182 may be permanently secured to the tray base 180, or may be integrally formed with the tray base 180. In another embodiment, the trays 126 may not include plant containers 182 and the soil may be received directly in the tray recess 140.

It will further be understood that each tray 126 from a floor member 124 may hold a different plant and/or a different soil and/or substrate than the other trays 126 from the same floor member 124.

In the illustrated embodiment, the rear side 130 of each tray 126, such as the front plant receiving tray 126a, is connected to the front side 128 of the adjacent plant receiving tray 126, i.e. plant receiving tray 126b in FIGS. 1A and 1B, located rearwardly from the tray 126 to define a tray train extending between the front end 120 and the rear end 122 of the storage frame 102. In this configuration, when the front plant receiving tray 126a is moved laterally outwardly from the storage frame 102, the remaining plant receiving trays 126 from the tray train are moved laterally along the horizontal guiding members 119 towards the open front end 120 of the storage frame 120.

The trays 126 are further detachably connected to each other to allow the front plant receiving tray 126a to be detached from the plant receiving tray 126b disposed immediately rearward of the front plant receiving tray 126a when the front plant receiving tray 126a is moved outwardly from the storage frame 102.

In one embodiment, when the front plant receiving tray 126a received on the displacement platform 164 reaches the desired tending unit 150, the front plant receiving tray 126a may be unloaded from the displacement platform 164 and into the desired tending unit 150 to allow the plants received on the front plant receiving tray 126a to be tended.

Once the front plant receiving tray 126a has been unloaded from the displacement platform 164, the displacement platform 164 may then be used for extracting another one of the trays 126 from the storage frame 102, or eventually used for extracting the front plant receiving tray 126a from the desired tending unit 150 once the plants have been tended and for returning the front plant receiving tray 126a to the corresponding vertical farming layer 104.

It will be understood that when the front plant receiving tray 126a is extracted from the storage frame 102, the plant receiving tray 126b located immediately rearwardly of the front plant receiving tray 126a, now detached from the front plant receiving tray 126a, is now adjacent the front end 120 of the storage frame 102.

Therefore, once the front plant receiving tray 126a has been unloaded from the displacement platform 164, the displacement platform 164 may then be moved back in vertical alignment with the plant receiving tray 126b and may extract the plant receiving tray 126b to move the plant receiving tray 126b towards the desired tending unit 150 or to another tending unit. This configuration therefore allows the trays 126 to be manipulated and displaced towards tending units 150 for the plants received on the trays to be tended.

To enable the trays 126 to be detachably connected together, the vertical farming system 100 includes a plurality of connection assemblies 170. Each connection assembly 170 detachably connects a first plant receiving tray (such as the front plant receiving tray 126a) with a second plant receiving tray adjacent the first plant receiving tray (such as the plant receiving tray 126b located immediately rearwardly of the front plant receiving tray 126a). More specifically, the connection assembly 170 extends between the rear side 130 of the first plant receiving tray 126a and the front side 128 of the second plant receiving tray 126b.

In the illustrated embodiment, the connection assembly 170 includes a rear connecting portion 172 located on the first plant receiving tray 126a and a front connecting portion 174 located on the second plant receiving tray 126b, the rear and front connecting portions 172, 174 being engageable with each other to thereby connect the first and second trays 126a, 126b together.

In the illustrated embodiment, all the trays 126 are identical to each other. Each tray 126 therefore includes both the rear and front connecting portions 172, 174. More specifically, the tray sidewall 138 includes a front tray wall 176 located at the front side 128 of the tray 126 and a rear tray wall 178 located at the rear side 130 of the tray 126. The rear connecting portion 172 is located on the rear tray wall 178 and the front connecting portion 174 is located on the front tray wall 176. Specifically, the rear connecting portion 172 includes a hook member 190 comprising a rear flange 192 which extends generally horizontally and rearwardly from the rear tray wall 178 and a hook end portion 194 extending downwardly from the rear flange 192. The hook member 190 defines a hook recess 196 which faces downwardly. The front connecting portion 174 includes a connecting flange 198 projecting frontwardly from the front tray wall 176. In the illustrated embodiment, the connecting flange 198 sized and shaped to be snuggly received in the hook recess 196. More specifically, the connecting flange 198 has a width corresponding generally to the width of the rear flange 192. This configuration contributes to preventing movement of connected trays 126 relative to each other when the trays 126 are moved together laterally.

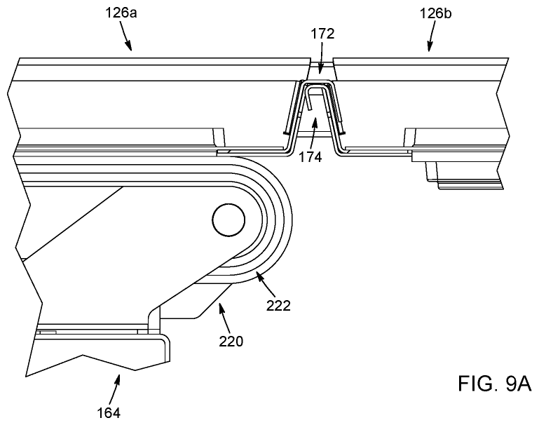

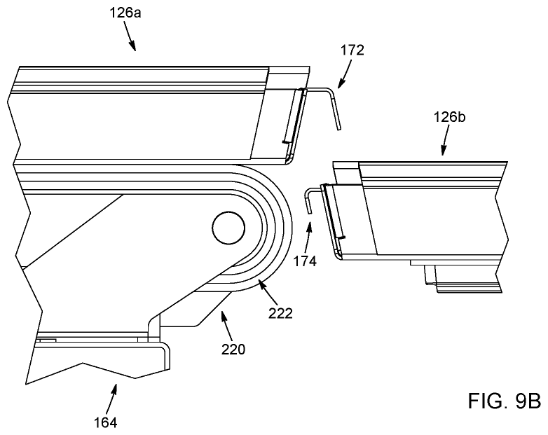

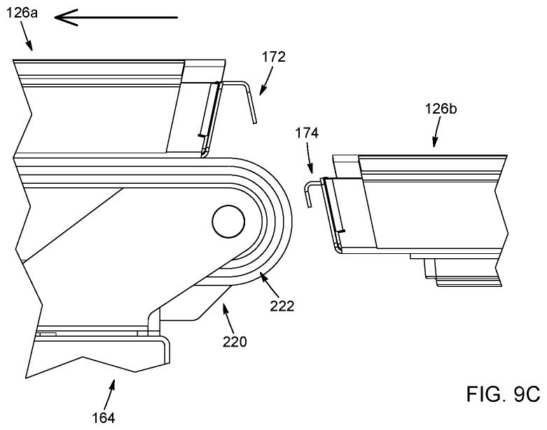

FIG. 9A to 9C show an example of a method for disconnecting the front plant receiving tray 126a from the adjacent tray 126b connected to the front plant receiving tray 126a, in accordance with one embodiment.

The front plant receiving tray 126a is first moved laterally onto the displacement platform 164 using the tray extraction mechanism 220. The displacement platform 164 is then raised at least slightly to disengage the rear connecting portion 172 from the front connecting portion 174, as shown in FIG. 9B. The front plant receiving tray 126a is then moved laterally at least slightly away from the adjacent tray 126b using the tray extraction mechanism 220 until the front plant receiving tray 126a is spaced horizontally from the adjacent tray 126b, as shown in FIG. 9C. This allows the front plant receiving tray 126a to clear the adjacent plant receiving tray 126b when the front plant receiving tray 126a is further moved vertically by the tray displacement assembly 160.

It will be appreciated that the configuration described above is merely provided as an example and that many alternative configurations are possible. For example, the first connecting portion could include a catch member and the second connecting portion could include a hook member adapted to engage the catch member. Alternatively, the second connecting portion could instead include a catch member and the first connecting portion could include a hook member adapted to engage the catch member. In another embodiment, both the first and second connecting portions could include hook members adapted to engage each other. In yet another embodiment, one or both of the first and second connecting portions could include electromagnets adapted to be powered to connect the adjacent trays together and unpowered to allow the first and second adjacent trays to be detached from each other.

In another embodiment, instead of including first and second connecting portions, the connection assembly 170 could instead include a single connector extending from one of the first and second plant receiving trays 126a, 126b, such as a hook, an electromagnet or any other types of connector, which is adapted to directly engage the other one of the first and second plant receiving trays 126a, 126b. For example, if the trays 126 are made of a ferromagnetic material, the connector may include an electromagnet secured to the first plant receiving tray 126a for magnetically engaging the second plant receiving tray 126b. Alternatively, if the connector includes a hook member, the trays 126 could include a corresponding opening adapted to receive the hook member.

In one embodiment, the connection assembly 170 could be configured to automatically disconnect the first plant receiving tray 126a from the second plant receiving tray 126b when the first plant receiving tray 126a is moved outwardly from the storage frame 102 such that it is entirely received in the vertical displacement space 162. For example, the connection assembly 170 or the storage frame 102 could include a cam member which could disconnect the connection assembly 170 when the connection assembly 170 is aligned horizontally with the open front end 120 of the storage frame 102. In one embodiment, the connection assembly 170 could be disconnected by vertical movement (upward or downward) of the displacement platform 164 when the first plant receiving tray 126a is received on the displacement platform 164.

In another embodiment, the connection assembly 170 could include a sensor disposed towards the front end of the storage area to detect the horizontal position of the first plant receiving tray 126a relative to the storage frame 102. In an embodiment in which the connection assembly includes an electromagnet, for example, the sensor and the electromagnet could be operatively connected to a controller which could unpower the electromagnet to thereby disconnect the connection assembly 170 upon a detection by the sensor that the first plant receiving tray 126a is entirely out of the storage frame 102.

Conversely, when the front plant receiving tray 126a is moved back from the displacement platform 164 into the vertical farming layer located on the same vertical level as the displacement platform 164, the first plant receiving tray 126a may be moved back into the storage frame 102.

As the first plant receiving tray 126a contacts the second plant receiving tray 126b, the connection assembly 170 may be reconnected such that the first and second plant receiving tray 126b are again connected to each other. It will be understood that by further pushing the first plant receiving tray 126a along the horizontal members 118 towards the rear end 122 of the storage frame 102, the remaining tray 126 will also be moved towards the rear end 122 until the trays 126 are back in the initial position.

It will be appreciated that this configuration greatly facilities the manipulation of the trays 126 and the displacement of the trays 126 towards the tending units 150 by allowing all trays 126 to be extracted from the plant storage frame 102 through the open front end 120.

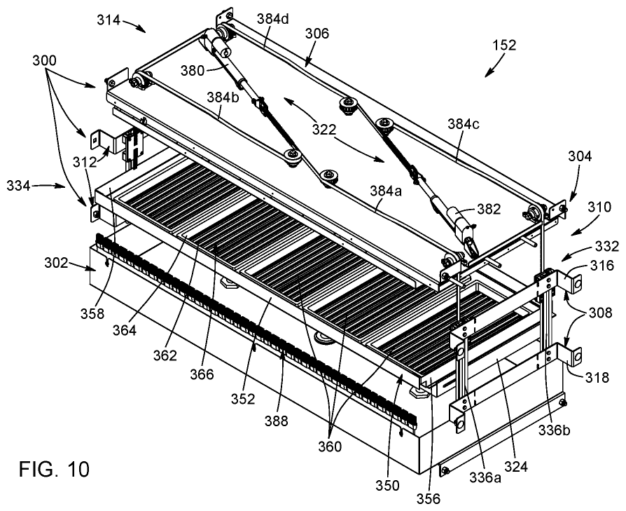

Now turning to FIGS. 10 to 12E, there is shown the irrigation unit 152 for the vertical farming system 100, in accordance with one embodiment. In this embodiment, the irrigation unit 152 includes an irrigation unit frame 300, an irrigation basin 302 secured to the frame 300 for receiving and holding an irrigation fluid such as water, a nutrient solution of the like, and a tray dipping assembly 304 for receiving a plant receiving tray 350 and selectively moving the tray 350 towards and away from the irrigation basin 302.

In this embodiment, the irrigation unit frame 300 includes a top plate 306 which extends substantially horizontally, a first bracket assembly 308 located at a first end 310 of the irrigation unit 152 and a second bracket assembly 312 located at a second end 314 of the irrigation unit 152 opposite the first end 310. More specifically, each bracket assembly 308, 312 includes an upper horizontal bracket 316 and a lower horizontal bracket 318 located below and spaced apart from the upper horizontal bracket 316. The top plate 306 and the upper and lower brackets can be secured to a support structure, not shown, such as vertical members similar to the vertical members of the plant storage frame 102.

In this embodiment, the plant receiving tray 350 is generally similar to the plant receiving tray 126 illustrated in FIGS. 1A, 1B and 5 to 8. Specifically, the tray 350 is generally rectangular and includes opposite front and rear sides 352, 354 extending parallel to each other and first and second lateral ends 356, 358 extending between the front and rear sides 352, 354.

In one embodiment, the plant receiving tray 350 may be configured to be used with the vertical farming system 100 illustrated in FIGS. 1A and 1B. Alternatively, the plant receiving tray 350 may be part of another vertical farming system which is configured differently from the vertical farming system 100 illustrated in FIGS. 1A and 1B.

In the illustrated embodiment, the plant receiving tray 350 further includes a plurality of rectangular container portions 360 disposed side-by-side on the tray 350 between the first and second lateral ends 356, 358. Each container portion 360 includes a bottom panel 362 and a rectangular sidewall 364 extending upwardly from the bottom panel 362 to define a recess 366 adapted for receiving soil or a soil substrate in which the plants are planted. The rectangular container portions 360 may be similar to the plant containers 182 described above and be removably mounted to the tray 350, or may be permanently secured to the tray 350.

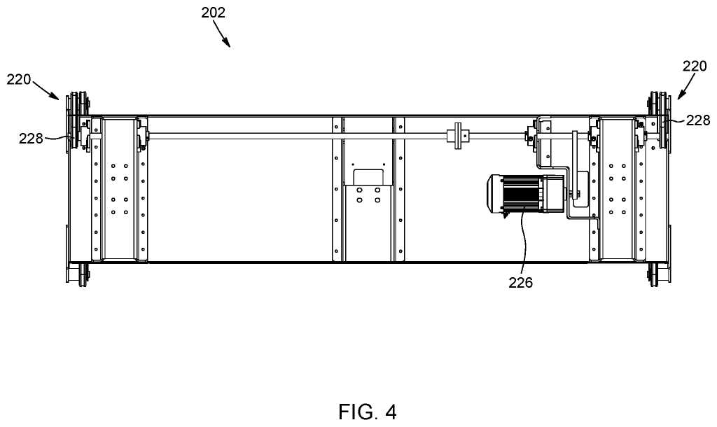

In the illustrated embodiment, the bottom panel 362 includes a plurality of irrigation openings 368 for allowing irrigation fluid to pass through. As best shown in FIG. 4, the irrigation openings 368 are made in the bottom panel 362 by punching through the bottom panel 362, which creates a plurality of projections 370 extending downwardly from the bottom panel 362, each projection 370 surrounding a corresponding irrigation opening 368. In this embodiment, the irrigation openings 368 are therefore generally elongated. Alternatively, the irrigation openings 368 could have any other shape, size or configuration which a skilled person would consider to be suitable. In yet another embodiment, instead of comprising a rigid piece of material in which holes are made, the bottom panel 362 could include a mesh material which allows irrigation fluid to pass through.

In the embodiment illustrated in FIGS. 10 to 12E, the tray dipping assembly 304 includes a support frame 320 for receiving the tray 350 and an actuator assembly 322 operatively connected to the support frame 320 for selectively raising and lowering the support frame 320.

The support frame 320 is substantially rectangular and has a first end 324 located towards the first end side 310 of the irrigation unit 152, a second end side 326 located towards the second end 314 of the irrigation unit 152 and first and second lateral sides 328, 330 extending generally perpendicular to the first and second end sides 324, 326. The support frame 320 is configured to receive the tray 350 such that when the tray is received on the support frame, the tray 350 extends generally parallel to the support frame 320. The support frame 320 is also hollow so as to avoid blocking the irrigation openings 368 at the bottom of the tray 350.

The irrigation unit 152 further includes first and second guide assemblies 332, 334 respectively located at the first and second ends 310, 314 of the irrigation unit 152 for guiding the plant receiving tray 350 towards and away from the irrigation basin 302. More specifically, each guide assembly 332, 334 includes a pair of vertical guide rails 336a, 336b extending parallel to each other and extending between the upper and lower horizontal brackets 316, 318 of each bracket assembly 308, 312.

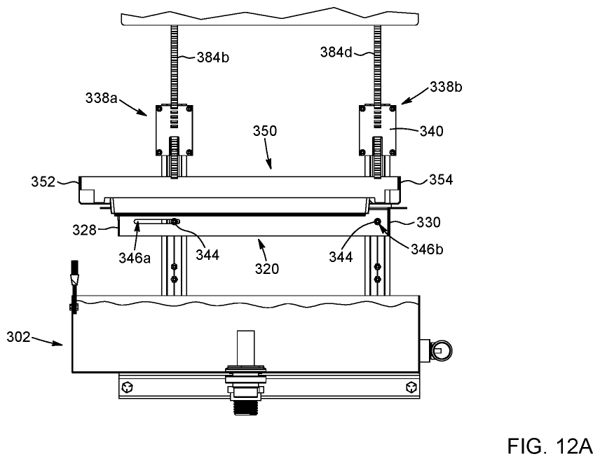

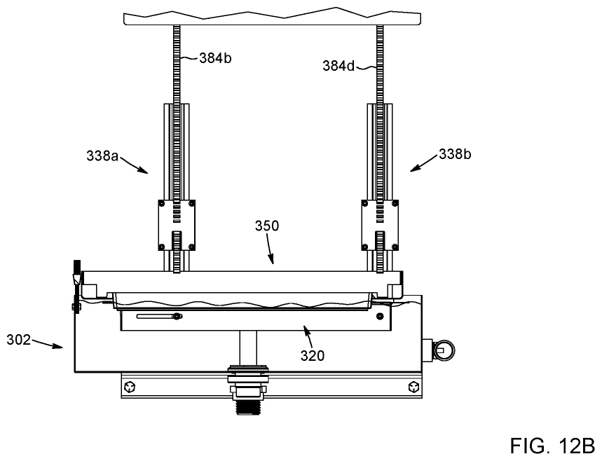

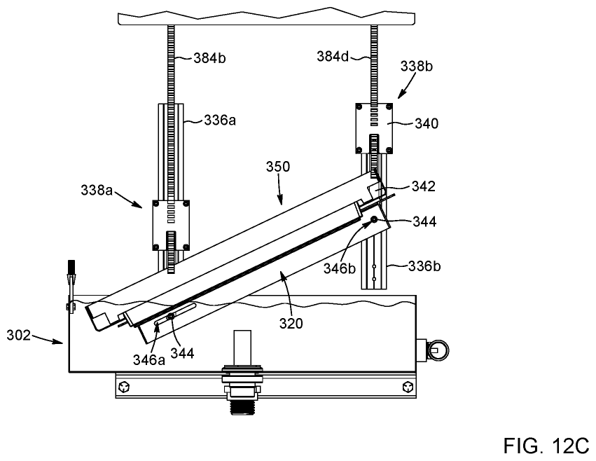

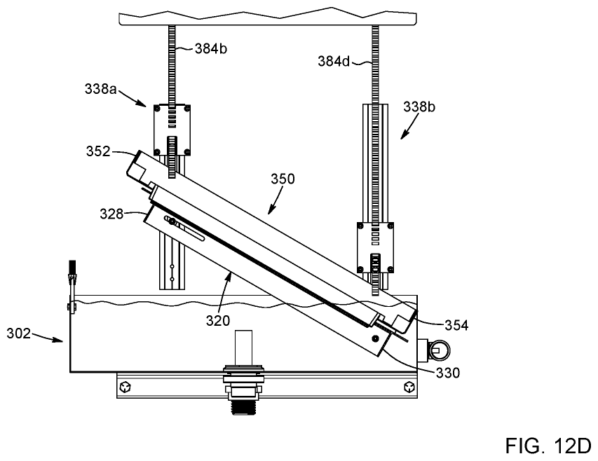

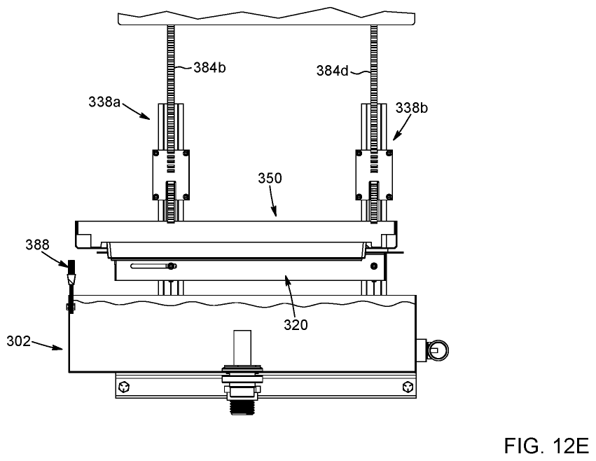

Each guide assembly 332, 334 further includes first and second guiding members 338a, 338b which each engage a corresponding vertical guide rail 336a, 336b so as to move along the corresponding guide rail 336a, 336b. Each guiding member 338a, 338b includes a guiding block 340 which slidably engages the corresponding vertical guide rail 336a, 336b and an elongated extension member 342, best shown in FIG. 12C, extending downwardly from the guiding block 340 for connection to the support frame 320. More specifically, each guide member 338a, 338b includes a pivot pin 344, best shown in FIGS. 12A to 12E, which extends from the extension member 342 towards the opposite end 310 or 314 of the irrigation unit 152 and which engages a corresponding pin receiving opening 346a, 346b defined in the support frame 320.

In the embodiment illustrated in FIGS. 10 to 12E, the actuator assembly 322 includes first and second actuators 380, 382 which are secured on top of the top plate 306. The first actuator 380 is operatively connected to the support frame 320 proximal the first lateral side 328 and the second actuator 382 is operatively connected to the support frame 320 proximal the second lateral side 330.

As shown in FIG. 10, the first actuator 380 is connected to the support frame 320 via the first guiding members 338a of the first and second guide assemblies 332, 334 and the second actuator 382 is connected to the support frame 320 via the second guiding members 338b of the first and second guide assemblies 332, 334. Specifically, the first actuator 380 is connected to the first guiding member 338a of the first guiding assembly 332 by a first movement belt 384a and to the first guiding member 338a of the second guiding assembly 334 by a second movement belt 384b. The first actuator 380 is configured to selectively extend and retract the first and second movement belts 384a, 384b simultaneously to thereby simultaneously move the first guiding members 338a upwardly or downwardly.

Similarly, the second actuator 382 is connected to the second guiding member 338b of the first guiding assembly 332 by a third movement belt 384c and to the second guiding member 338b of the second guiding assembly 332 by a fourth movement belt 384d. The second actuator 380 is configured to selectively extend and retract the third and fourth movement belts 384c, 384d simultaneously to thereby simultaneously move the second guiding members 338b upwardly or downwardly.

In this configuration, the support frame 320, and therefore the tray 350 received on the support frame 320, may be raised or lowered while remaining in a horizontal orientation by simultaneously operating both the first and second actuators 380, 382 at the same actuation speed. Each one of the first and second actuators 380, 382 could further be operated individually to raise one of the first and second lateral sides 328, 330 of the support frame 320 to thereby incline the support frame, and therefore the tray 350 received on the support frame 320, towards one of the first and second lateral sides 328, 330.

It will be understood that the first and second guiding members 338a, 338b of each guide assembly 332, 334 are spaced from each other by a lateral distance defined by a distance between the vertical guide rails 336a, 336b, and therefore remain at this lateral distance when moving vertically along the vertical guide rails 336a, 336b. Because of this configuration, to be able to incline the support frame 320, the four pin receiving openings 346a, 346b defined in the support frame 320 are not identical to each other. Instead, the pin receiving openings 346a located towards the first lateral side 328 of the support frame 320 include elongated slots generally parallel to the support frame 320 for rotatably and slidably receiving the pivot pins 344 of the first guiding members 338a. In contrast, the pin receiving openings 346a located towards the second lateral side 330 are generally circular and are sized and shaped to rotatably receive the pivot pins 344 of the second guiding members 338b.

To irrigate the plants received in the tray 350 using the irrigation unit 152, the tray 350 is first displaced towards the irrigation unit 152 and received on the support frame 320. In one embodiment, the tray 350 may be moved from the plant storage frame 102 described above to the irrigation unit 152. In this position, shown in FIG. 12A, the irrigation basin 302 is spaced downwardly from the support frame 320. Irrigation fluid is provided in the irrigation basin 302, either before the tray 350 is displaced, during displacement of the tray 350 or after the tray 350 has been displaced towards the irrigation unit 152 and received on the support frame 320. As shown in FIG. 12B, both the first and second actuators 380, 382 may then be operated simultaneously and at the same actuation speed to extend the movement belts 384a, 384b, 384c, 384d to thereby lower the support frame 320, and thereby the tray 350, towards the irrigation basin 302 until the bottom panel 362 of the tray 350 contacts the surface of the irrigation fluid or is at least partially immersed in the irrigation fluid within the irrigation basin 302. The tray 350 may then be left in this position for a predetermined period of time to allow the irrigation fluid to penetrate the soil in the tray 350 by capillarity and thereby irrigate the plants received in the tray 350.

In the embodiment illustrated in FIGS. 12A to 12E, the support frame 320 is then inclined to incline the tray 350. It will be appreciated that inclining the support frame 320 may serve to distribute the irrigation fluid substantially evenly within the soil in the tray 350, and/or to drain excess irrigation fluid from the tray 350. As shown in FIG. 12C, the second lateral side 330 is first raised relative to the first lateral side 328 by operating the second actuator 382. The second lateral side 330 is then lowered and the first lateral side 328 is then raised relative to the second lateral side 330 by operating the first actuator 380, as shown in FIG. 12D.

Alternatively, the first lateral side 328 could first be raised relative to the second lateral side 330, and then the second lateral side 330 could be raised relative to the first lateral side 328. In yet another embodiment, the support frame 320 may not be inclined. The support frame 320 may instead be raised while remaining horizontal by operating the first and second actuators 380, 382 simultaneously and at the same actuation speed.

In the illustrated embodiment, the irrigation unit 152 further includes a row of brushes 388 which face upwardly and which are disposed adjacent the irrigation basin 302, towards the first lateral side 328 of the support frame 320. Once the tray 350 has been drained of excess water, the support panel 320 may be positioned at a certain height using the first and second actuators 380, 382 such that the bottom panel 362 of the tray 350 is generally on a common horizontal plane with the brushes 388, as shown in FIG. 12E. The tray 350 may then be moved laterally out from the support frame 320 towards the brushes 388 such that the brushes 388 brush the underside of the bottom panel 362 so as to further remove excess irrigation fluid and/or debris from the bottom panel 362.

In one embodiment, the tray 350 is moved laterally from the irrigation unit 152 using the tray displacement assembly 160 and is returned to the plant storage frame 102 for storage. Alternatively, the tray 350 could instead be moved towards another tending unit 150. In yet another embodiment, the irrigation unit 152 and the tray 350 may not be part of the vertical farming system 100, and the tray 350 may be moved to another location following irrigation.

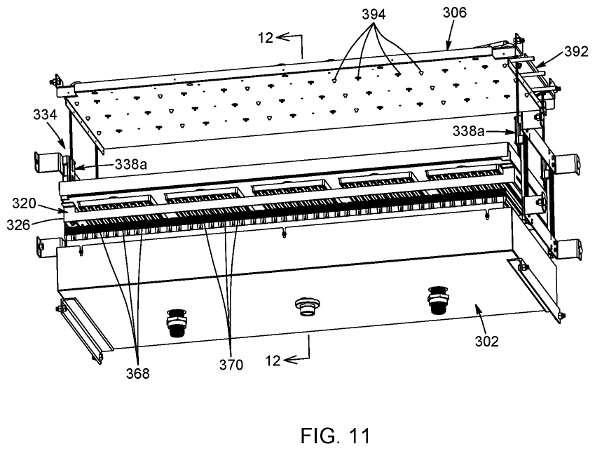

In the illustrated embodiment, the irrigation unit 152 further includes an auxiliary irrigation system 392 which allows further irrigation of the plants in the plant receiving tray 350 received in the irrigation unit 152 if desired or necessary. Specifically, the auxiliary irrigation system 392 is located within the top plate 306 and is configured for spraying the plants with irrigation fluid from above through spray holes or nozzles 394, shown in FIG. 11, located in the underside of the top plate 306. The auxiliary irrigation system 392 could be used simultaneously to lowering the tray 350 in the basin 102, before lowering the tray 350 in the basin 102 or after the tray 350 has been lowered in the basin 102. Alternatively, the irrigation unit 152 may not include any auxiliary irrigation system 392.

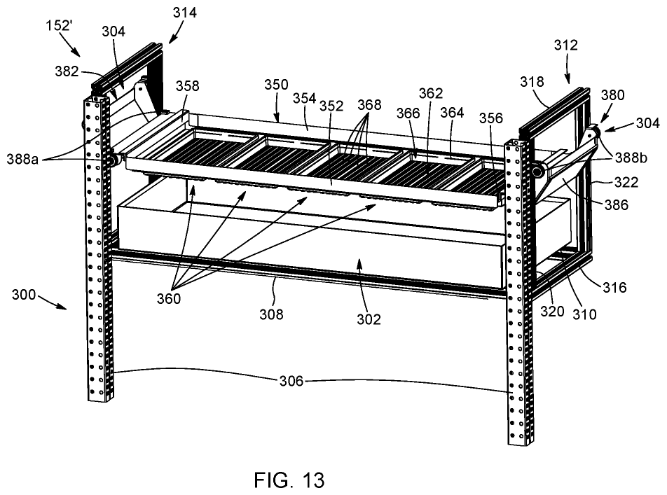

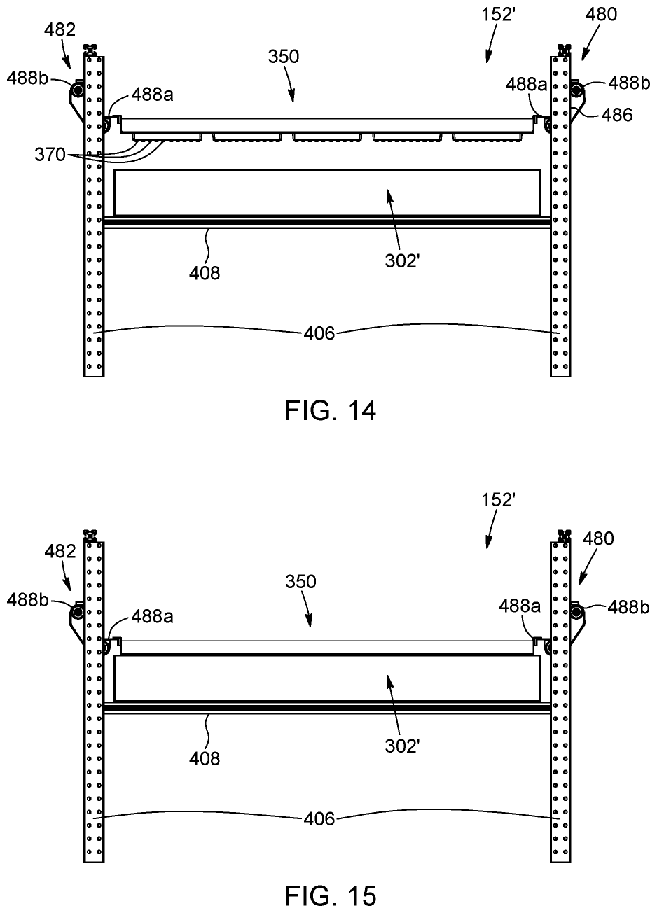

Turning now to FIGS. 13 to 15, there is shown an irrigation unit 152′ for the vertical farming system 100, in accordance with an alternative embodiment. The irrigation unit 152′ is adapted to be used with the plant receiving tray 350 disclosed above. In this alternative embodiment, the irrigation unit 152′ includes an irrigation unit frame 300′, an irrigation basin 302′ secured to the frame 300′ for receiving and holding an irrigation fluid such as water, a nutrient solution of the like, and a tray dipping assembly 304′ for receiving the plant receiving tray 350 and selectively moving the tray 350 towards and away from the irrigation basin 302′. In the illustrated embodiment, the irrigation unit frame 300′ includes a pair of front vertical corner posts 406, a pair of rear vertical corner posts, not shown, and front and rear base members 408, 410 extending horizontally respectively between the front and rear vertical corner posts 406 for supporting the irrigation basin 402.

The irrigation unit frame 300′ further includes first and second end guiding assemblies 412, 414 for guiding the tray 350 towards and away from the irrigation basin 302′. In the illustrated embodiment, each end guiding assembly 412, 414 includes spaced-apart lower and upper transversal horizontal members 416, 418 extending between corresponding front and rear vertical posts 406, perpendicular to the front and rear base members 408, 410, and a pair of parallel vertical guide rails 420, 422 extending generally vertically between the lower and upper transversal horizontal members 416, 418, generally along a corresponding vertical post 406.

In the illustrated embodiment, the tray dipping assembly 304′ is adapted to engage the first and second lateral ends 356, 358 of the tray 350 and to move the tray 350 towards and away from the irrigation basin 302′ while maintaining the tray 350 generally horizontal. More specifically, the tray dipping assembly 304′ includes a first end carriage 480 for receiving the first lateral end 356 of the tray 350 and a second end carriage 482 for receiving the second lateral end 358 of the tray 350. The first end carriage 480 is mounted to the first end guide assembly 412, while the second end carriage 482 is mounted to the second end guide assembly 414.

More specifically, each end carriage 480, 482 includes a body 486 extending transversely to the tray 350 between the vertical guide rails 420, 422 of the corresponding end guide assembly 412, 414 and a plurality of rollers 488a, 488b rotatably mounted to the body 486 and engaging the vertical guide rails 420, 422.

In the illustrated embodiment, the rollers 488a, 488b include a pair of lower rollers 488a mounted opposite to each other and contacting the vertical guide rails 420, 422, and a pair of upper rollers 488b mounted opposite to each other and also contacting the vertical guide rails 420, 422. More specifically, the lower rollers 488a are disposed towards each other and the upper rollers 488b are disposed away from each other such that each vertical guide rail 420, 422 is disposed between a corresponding lower roller 488a and a corresponding upper roller 488b.

Each end carriage 480, 482 is further operatively connected to a carriage actuator for moving the end carriage 480, 482 vertically upwardly and downwardly along the corresponding vertical guide rails 420, 422. In one embodiment, both end carriages 480, 482 are connected to the carriage actuator to move simultaneously along the corresponding vertical guide rails 420, 422.

In one embodiment, the carriage actuator could include a rotary actuator, such as an electric motor or the like, and be connected to the rollers 488a, 488b to selectively rotate the rollers 488a, 488b and thereby cause the end carriages 480, 482 to move vertically along the vertical guide rails 420, 422. In another embodiment, the carriage actuator could include a linear actuator, such as a pneumatic actuator, a worm gear actuator or the like, and be operatively connected to at least one of the end carriages 480, 482 to push and/or pull the end carriage 420, 422 vertically along the vertical guide rails 420, 422.

To irrigate the plants received in the tray 350 using the irrigation unit 152′, the tray 350 is first displaced towards the irrigation unit 152′ and received in the end carriages 480, 482 above the irrigation basin 302′, with the irrigation basin 302′ being spaced downwardly from the tray 350. Irrigation fluid is provided in the irrigation basin 302′, either before the tray 350 is displaced, during displacement of the tray 350 or after the tray 350 has been displaced towards the irrigation unit 152′ and received in the end carriages 480, 482. The end carriages 480, 482 may then be moved downwardly such that the tray 350 is also moved vertically downwardly towards the irrigation basin 302′ until the bottom panel 362 of the tray 350 contacts the surface of the irrigation fluid or is at least partially immersed in the irrigation fluid within the irrigation basin 302′. The tray 350 may then be left in this position for a predetermined period of time, and then raised such that the bottom panel 362 is moved out of the irrigation fluid and away from the irrigation basin 302′ thereby stop the irrigation of the plants.

In another embodiment, the carriage actuator may be operatively connected to a sensor adapted to measure a humidity level of the soil or the soil substrate in which the plants are planted. In this embodiment, the carriage actuator may be configured for raising the tray 350 such that the bottom panel 362 is moved out of the irrigation fluid and away from the irrigation basin 302′ when the measured humidity level is above a predetermined threshold.

In yet another embodiment, the irrigation unit 152′ may not include a tray dipping assembly 304′. Instead, the irrigation basin 302′ may be configured to be moved vertically towards and away from the tray 350. Specifically, instead of a tray dipping assembly 304′, the irrigation unit 152′ may instead include an irrigation basin elevation assembly operatively connected to the irrigation basin 302′ to move the irrigation basin 302′ vertically relative to the irrigation unit frame 300′.

In this embodiment, to irrigate the plants received in the tray 350, the tray 350 is first displaced towards the irrigation unit 152 and aligned vertically with the irrigation basin 302, with the irrigation basin 302 being spaced downwardly from the tray. Irrigation fluid is provided in the irrigation basin 302, either before the tray 350 is displaced, during displacement of the tray 350 or after the tray 350 has been displaced towards the irrigation unit 152 and aligned vertically with the irrigation basin 302. The irrigation basin 302′ may then be moved vertically upwardly towards the tray 350 using the irrigation basin elevation assembly until the bottom panel 362 of the tray 350 contacts the surface of the irrigation fluid or is at least partially immersed in the irrigation fluid within the irrigation basin 302′. In this embodiment, since the irrigation unit 152′ does not include a tray dipping assembly, the tray 350 is not configured to be moved vertically at all within the irrigation unit 152′. Alternatively, the irrigation unit 152′ could include both a tray dipping assembly 304′, as described above, and the irrigation basin manipulation assembly. In this embodiment, during irrigation, as the irrigation basin 302′ is moved upwardly, the tray 350 may be moved simultaneously downwardly, thereby reducing the time required for the bottom panel 362 of the tray 350 to contact the irrigation fluid in the irrigation basin 302′.

It will be appreciated that providing irrigation fluid to the plants from underneath and letting it penetrate the soil by capillarity could provide a more even irrigation throughout the soil and may be less messy than spraying irrigation fluid onto the plants and soil from above.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A vertical farming system comprising:
a plant storage frame including a plurality of horizontal guiding members spaced apart vertically from each other, the plant storage frame having an open front end for allowing access into the storage frame;
a plurality of plant receiving trays received on a corresponding horizontal guiding member for receiving a plurality of plants, the plant receiving trays being disposed adjacent to each other and substantially in a common plane to define a vertical farming layer, the plant receiving trays being laterally movable along the horizontal guiding members towards and away from the open front end of the storage frame, the plant receiving trays being connectable to each other such that movement of one of the plant receiving trays in a lateral direction moves the remaining plant receiving trays in the same lateral direction, the plant receiving trays being further detachable from each other to allow each plant receiving tray to be removed from the storage frame through the open front end to be tended individually from the other plant receiving trays.

2. The system as claimed in claim 1, wherein each tray includes a front tray end located towards the front end of the storage frame and a rear tray end located away from the front end of the storage frame, the rear tray end of each tray being detachably connectable to the front tray end of an adjacent plant receiving tray located rearwardly from the tray such that when the front one of the plant receiving trays is moved laterally along the horizontal members, the remaining plant receiving trays are also moved laterally along the horizontal members.

3. The system as claimed in claim 2, wherein each tray includes a bottom panel having an outer panel edge and a tray sidewall extending upwardly from the outer panel edge.

4. The system as claimed in claim 3, wherein the tray sidewall includes a front tray wall located at the front tray end and a rear tray wall located that the rear tray end, the front tray wall including a first connecting portion and the rear tray wall including a second connecting portion configured engageable with the first connecting portion such that the second connecting portion of each tray is configured to engage the first connecting portion of the adjacent plant receiving tray located rearwardly from the tray.

5. The system as claimed in claim 4, wherein the second connecting portion includes a hook member having a hook recess facing downwardly to receive the first connecting portion of the adjacent plant receiving tray located rearwardly from the tray.

6. The system as claimed in claim 5, wherein the first connecting portion includes a connecting flange projecting frontwardly from the front tray wall, the connecting flange being sized and shaped to be snuggly received in the hook recess of the second connecting portion.

7. The system as claimed in claim 3, wherein each tray includes a tray base having a plurality of cut-out portions and a plurality of plant containers containing the plants, each cut-out portion being sized and shaped to removably receive a corresponding plant container.

8. The system as claimed in claim 1, further comprising:
at least one tending unit for tending to plants;
a tray displacement assembly disposed adjacent the open front end of the plant storage frame for selectively moving at least one of the plant receiving trays from the plant storage frame to one of the at least one tending unit for tending to the plants received in the at least one of the plant receiving trays and from the at least one tending unit to the plant storage frame to return the at least one of the plant receiving trays to storage in a corresponding vertical farming layer.

9. The system as claimed in claim 8, wherein the tray displacement assembly includes:
a displacement platform sized and shaped to receive the front one of the plant receiving trays;
a tray extraction mechanism mounted to the displacement platform for engaging the front one of the plant receiving trays received in the storage frame at a first vertical level and for moving the front one of the plant receiving trays laterally outwardly from the storage frame onto the displacement platform; and
an actuator operatively connected to the displacement platform to move the displacement platform vertically to thereby move the front one of the plant receiving trays vertically to the one of the at least one tending units located at a second vertical level different from the first vertical level.

10. The system as claimed in claim 8, wherein the at least one plant tending unit includes an irrigation unit for irrigating the plants received in the plant receiving tray.

11. The system as claimed in claim 1, wherein the plant receiving trays are slidably received on the horizontal members.

12. A method for tending to plants, the method comprising:
providing a vertical farming system as defined in claim 1;
providing at least one tending unit for tending to the plants and a tray displacement assembly disposed adjacent the open front end of the plant storage frame;
using the tray displacement assembly, moving a front one of the plant receiving trays laterally outwardly from one of the vertical farming layers of the storage frame through the open front end; and
using the tray displacement assembly, moving the front one of the plant receiving trays vertically relative to the storage frame towards one of the at least one tending unit.

13. The method as claimed in claim 12, wherein the front one of the plant receiving trays is removably connected to an adjacent plant receiving tray located rearwardly from the front tray one of the plant receiving trays, the method further comprising:
after moving the front one of the plant receiving trays laterally outwardly from one of the vertical farming layers, moving the front one of the plant receiving trays upwardly to disconnect the front one of the plant receiving trays from the adjacent plant receiving tray.

14. The method as claimed in claim 13, further comprising:
after moving the front one of the plant receiving trays upwardly, moving the front one of the plant receiving trays laterally outwardly from the plant storage frame until the front one of the plant receiving trays is spaced horizontally from the adjacent plant receiving tray to allow the front one of the plant receiving trays to clear the adjacent plant receiving tray when the front one of the plant receiving trays is further moved vertically.

15. An irrigation unit for a vertical farming system, the vertical farming system including at least one plant receiving tray for receiving plants thereon, the at least one plant receiving tray including a bottom panel having at least one irrigation opening, the irrigation unit comprising:
an irrigation unit frame;
an irrigation basin secured to the irrigation unit frame for receiving an irrigation fluid;
a tray dipping assembly movably connected to the irrigation unit frame for receiving at least one plant receiving tray, the tray dipping assembly being movably connected to the irrigation unit frame for moving the plant receiving tray vertically towards the irrigation basin until the bottom panel of the plant receiving tray is at least partially immersed in the irrigation fluid in the irrigation basin to thereby provide irrigation fluid to the plants through the at least one irrigation opening of the plant receiving tray.

16. The irrigation unit as claimed in claim 15, further comprising at least one guide assembly connected to the frame for guiding the tray towards the irrigation basin.

17. The irrigation unit as claimed in claim 15, wherein the tray dipping assembly includes a tray support member movably connected to the irrigation frame, the tray support member being configured for receiving the at least one plant receiving tray, the tray dipping assembly further comprising at least one actuator operatively connected to the tray support member for vertical movement of the tray support member.

18. The irrigation unit as claimed in claim 17, wherein the at least one actuator includes a first actuator operatively connected to a first side of the tray support member and a second actuator operatively connected to a second side of the tray support member located opposite the first side, the first actuator being operable individually from the second actuator for raising one of the first and second sides of the tray support member relative to the other one of the first and second sides of the tray support member to thereby incline the at least one plant receiving tray received on the tray support member.

19. A method for irrigating plants in a vertical farming system, the method comprising:
providing plants in a plant receiving tray, the plant receiving tray including a bottom panel having at least one irrigation opening;
positioning the plant receiving tray on a tray dipping assembly of an irrigation unit, the irrigation unit comprising an irrigation basin located below the tray dipping assembly, the irrigation basin containing an irrigation fluid;
using the tray dipping assembly, moving the plant receiving tray vertically downwardly towards the irrigation basin until the bottom panel is at least partially immersed in the irrigation fluid in the irrigation basin to thereby irrigate the plants with the irrigation fluid through the at least one irrigation opening of the plant receiving tray.

20. The method as claimed in claim 19, further comprising:
after moving the plant receiving tray vertically downwardly towards the irrigation basin, inclining the plant receiving tray using the tray dipping assembly.

21. The method as claimed in claim 19, further comprising:
before positioning the plant receiving tray on the tray dipping assembly, moving the plant receiving tray from a plant storage frame of the vertical farming system towards the tray dipping assembly.

22. A vertical farming system comprising:
a plant storage area for storing a plurality of plants in a plurality of vertical farming layers;
a tending unit located remotely from the plant storage area for tending to the plants when the plants are received in the tending unit;
a plant displacement assembly disposed between the plant storage area and the tending unit for selectively moving at least one plant from the storage area to the tending unit to allow the at least one plant to be tended and from the tending unit to the plant storage area to allow the plant unit to be returned to storage.

23. The system as claimed in claim 22, wherein the tending unit includes an irrigation unit for irrigating the plants.

24. The system as claimed in claim 22, further including a plurality of plant receiving trays disposed in the plant storage area, the plant receiving trays being configured for receiving the plants, the plant displacement assembly being adapted for selectively moving each plant receiving tray individually away from the other plant receiving trays towards the tending unit to allow each plant receiving tray to be tended individually.
